(19) United States
(12) Patent Application Publication
(10) Pub. No.: US 2013/0169563 A1
(43) Pub. Date: Jul. 4, 2013

(54) STORAGE MEDIUM STORING INFORMATION PROCESSING PROGRAM, INFORMATION PROCESSING APPARATUS, INFORMATION PROCESSING METHOD, AND INFORMATION PROCESSING SYSTEM

(71) Applicant: NINTENDO CO., LTD., Kyoto (JP)

(72) Inventor: Hiroki SOTOIKE, Kyoto (JP)

(73) Assignee: NINTENDO CO., LTD., Kyoto (JP)

(21) Appl. No.: 13/664,004

(22) Filed: Oct. 30, 2012

(30) Foreign Application Priority Data
Dec. 28, 2011 (JP) 2011-287728

(51) Int. Cl. G06F 3/041

(52) U.S. Cl. 345/173; 345/156

(57) ABSTRACT

An information processing system 100 of an example includes: an operation information acquisition section 11 acquiring operation information; a displayed part setting section 12 that sets the displayed part to a first part on the basis of the operation information according to a first operation, and sets the displayed part to a second part on the basis of the operation information according to a second operation subsequent to the first operation; and a display controller 13 that causes the display panel 30 to display the display object. The displayed part setting section 12 sets the displayed part at a first interval on the basis of the operation information according to the first operation, and sets the displayed part at a second interval different from the first interval on the basis of the operation information according to the second operation.

### CROSS REFERENCE TO RELATED APPLICATION

The disclosure of Japanese Patent Application No. 2011-287728, filed on Dec. 28, 2011 is incorporated herein by reference.

### BACKGROUND OF THE INVENTION

1. Field of the Invention

The technology herein relates to a storage medium having stored therein an information processing program causing a computer to function, an information processing apparatus that can display a part of a display object and set the displayed part in the display object, and an information processing method, and an information processing system.

2. Description of the Related Art

Conventionally, an information processing system has been known that displays a part of a display object in the case where the display object cannot be displayed on a display screen at one time, such as cases of an electronic book including a plurality of pages and a plurality of sequentially arranged images, and sets the displayed part in response to a user's operation.

For instance, in the case of viewing an electronic book, a display object of a page or a double page spread (two pages) can be displayed on a display screen, and a page succeeding or preceding the currently displayed page can be displayed according to a user's operation. Also in the case of displaying sequentially arranged images, one image or a thumbnail display image including thumbnail images can be displayed on the display screen and then an image preceding or succeeding the displayed image or a thumbnail display image preceding or succeeding the displayed thumbnail display image can be displayed in response to a user's operation.

Hereinafter, an operation of setting a part in an entire display object that is to be displayed, i.e. an operation of moving to the preceding or succeeding page in the case of an electronic book, or an operation of displaying the preceding or succeeding image or the thumbnail display image in the arrangement sequence in the case of a plurality of sequentially arranged images, is referred to as a “display feeding operation”.

A user's operation for performing a display feeding operation is, for instance, sliding a finger on the touch panel (moving in a state where the finger is in contact) as if flipping the display object or sliding the display object in the case where the display screen is a touch panel.

The display feeding operation is an operation of moving a part of a display object displayed on the display screen to an adjacent part in response to a user's operation. That is, in the case of an electronic book, the operation is an operation of moving to a preceding or succeeding page; in the case where a plurality of sequentially arranged images, the operation is an operation of moving to an image or a thumbnail display image that is preceding or succeeding in the arrangement sequence. Instead, an information processing system has been known that allows a display feeding operation largely moving the part of the display object to be displayed on the display screen.

For instance, there is an information processing system that moves, by pages, a part of the display object to be displayed on the display screen in accordance with a movement amount and/or a movement speed of a slide operation. In such an information processing system, for instance, a scroll bar having a length in accordance with the entire display object and a slider moving along the scroll bar are displayed on the display screen. A user moves the slider, thereby allowing moving by a plurality of pages.

This application describes an information processing apparatus that displays a part of a display object, can set a displayed part of the display object and set an interval of the displayed part, a storage medium storing an information processing program causing a computer to function as such an information processing apparatus, an information processing method, and an information processing system.

### SUMMARY OF THE INVENTION

A storage medium of an example embodiment stores an information processing program. This information processing program causes a computer of an information processing apparatus setting a displayed part in a display object on the basis of a user's operation to function as: an operation information acquisition section that acquires operation information according to the user's operation; a displayed part setting section that sets the displayed part to a first part on the basis of the operation information according to a first operation, and sets the displayed part to a second part on the basis of the operation information according to a second operation related to the first operation; and a display controller that displays the part of the display object set by the displayed part setting section, wherein the displayed part setting section sets the displayed part at a first interval on the basis of the operation information according to the first operation, and sets the displayed part at a second interval different from the first interval on the basis of the operation information according to the second operation.

According to this configuration, the first operation is performed, thereby allowing the displayed part in the display object to be set to the first part at the first interval. The second operation related to the first operation is performed, thereby allowing the displayed part in the display object to be set to the second part at the second interval different from the first interval.

In the case where the display object is a book including a plurality of pages, the first interval may, for instance, be set at each page, and the second interval may, for instance, be set at each chapter including a plurality of pages. In the case where the display object is a plurality of images arranged with respect to the imaging date, the first interval may, for instance, be set for each image, and the second interval may, for instance, be set at each imaging year of the images.

The second operation related to the first operation includes that the second operation is performed within a prescribed time after completion of the first operation, that the second operation is performed without intervention of another operation after the first operation, and that the second operation is performed in a situation where the first operation is valid. However, the operation is not limited thereto.

In the information processing program, the second interval may be larger than the first interval.

According to this configuration, in the case where the second operation related to the first operation is performed, the displayed part is set at a large interval to allow the second part to be displayed.

In the information processing program, the first operation and the second operation may be types of operations different from each other to an identical operation target.

This configuration negates the need of the second operation to another operation target after the first operation, and allows the second operation related to the first operation to be smoothly performed. The first operation and the second operation may be operations performed to the identical operation target in the operation directions different from each other. The operation target may be, for instance, a slider moving along a scroll bar.

In the information processing program, the second operation may be an operation performed subsequently to the first operation.

This configuration allows the second operation related to the first operation to be easily performed.

In the information processing program, the first operation may be an operation moving a slider along a scroll bar corresponding to the entire display object, and the second operation related to the first operation may be an operation performed to the slider after the slider is moved along the scroll bar. The second operation related to the first operation may be a gesture operation.

According to this configuration, an operation performed to one operation target that is the slider moving along the scroll bar allows the displayed part to be set at the first interval and also at the second interval. The gesture operation as the second operation may be an operation whose direction is designated, such as the flick operation, or various operations drawing prescribed trajectories. For instance, the second operation may be a flick operation in a direction perpendicular to the scroll bar in a state where the first operation moves the slider. The first operation may be an operation of moving the slider by dragging, or an operation of designating a position to which the slider is intended to be moved on the scroll bar.

The information processing program may further cause the information processing apparatus to function as a mark provider providing marks that are associated with the scroll bar and indicate positions set at the second interval.

According to this configuration, the second part can be grasped on the scroll bar, and it is easily understood at which position on the scroll bar the second operation subsequent to the first operation should be performed.

In the information processing program, the first operation and the second operation may be operations whose operation directions are different from each other.

This configuration allows the first operation and the second operation to be clearly discriminated.

In the information processing program, the first operation may be an operation to a displayed part of the display object, the displayed part setting section may set the displayed part on the basis of the operation information according to the first operation, the display controller may set the displayed part in a part of the displayed display object, continuously even after completion of the first operation according to an amount and/or a speed of the first operation, and the second operation may be an operation set when the displayed part is being set by the display controller.

According to this configuration, a direct operation to the display object allows the display feeding operation onto the display object to be performed by the inertia of the operation. The second operation in the middle of the display feeding operation by the inertia allows setting at the second interval and moving to the second part. Note that, in the case where the display object is displayed on the touch panel, the first operation may be, for instance, a slide operation or a flick operation to the display object. The second operation may be a tap operation to the display object to be performed in the middle of the display feeding operation by the first operation due to the inertia.

In the information processing program, the displayed part setting section may set the displayed part to a part displayed at a second interval having a certain relationship with the part displayed at the first interval based on the first operation on the basis of the operation information according to a second operation subsequent to the first operation.

This configuration allows the first operation preceding the second operation to designate to which part displayed at the second interval the movement is destined.

A storage medium of another example embodiment stores an information processing program causing a computer of an information processing apparatus setting a displayed part in a display object on the basis of a user's operation to function as: an operation information acquisition section that acquires operation information according to the user's operation; a displayed part setting section that sets the displayed part to a first part on the basis of the operation information according to a first operation, and sets the displayed part to a second part on the basis of the operation information according to a second operation whose type is different from the first operation to an operation target identical to an operation target on which the first operation is performed; and a display controller that displays the part of the display object set by the displayed part setting section, wherein the displayed part setting section sets the displayed part at a first interval on the basis of the operation information according to the first operation, and sets the displayed part at a second interval different from the first interval on the basis of the operation information according to the second operation.

According to this configuration, the first operation is performed to the operation target, thereby allowing the displayed part in the display object to be set to the first part at the first interval. The second operation is performed to the identical operation target, thereby allowing the displayed part in the display object to be set to the second part at the second interval different from the first interval. Furthermore, this configuration negates the need to perform the second operation to another operation target after the first operation. Even in the case of performing the second operation related to the first operation, the second operation can be smoothly performed.

An information processing apparatus of an example embodiment setting a displayed part in a display object on the basis of a user's operation, includes: an operation information acquisition section that acquires operation information according to the user's operation; a displayed part setting section that sets the displayed part to a first part on the basis of the operation information according to a first operation, and sets the displayed part to a second part on the basis of the operation information according to a second operation subsequent to the first operation; and a display controller that displays the part of the display object set by the displayed part setting section, wherein the displayed part setting section sets the displayed part at a first interval on the basis of the operation information according to the first operation, and sets the displayed part at a second interval different from the first interval on the basis of the operation information according to the second operation.

Also according to this configuration, the first operation is performed, thereby allowing the displayed part in the display object to be set to the first part at the first interval. The second operation related to the first operation is performed, thereby allowing the displayed part in the display object to be set to the second part at the second interval different from the first interval.

An information processing apparatus of another example embodiment setting a displayed part in a display object on the basis of a user's operation, includes: an operation information acquisition section that acquires operation information according to the user's operation; a displayed part setting section that sets the displayed part to a first part on the basis of the operation information according to a first operation, and sets the displayed part to a second part on the basis of the operation information according to a second operation whose type is different from the first operation to an operation target identical to an operation target on which the first operation is performed; and a display controller that displays the part of the display object set by the displayed part setting section, wherein the displayed part setting section sets the displayed part at a first interval on the basis of the operation information according to the first operation, and sets the displayed part at a second interval different from the first interval on the basis of the operation information according to the second operation.

Also according to this configuration, the first operation is performed to the operation target, thereby allowing the displayed part in the display object to be set to the first part at the first interval. The second operation is performed to the identical operation target, thereby allowing the displayed part in the display object to be set to the second part at the second interval different from the first interval. This configuration negates the need to perform the second operation to another operation target after the first operation. Even in the case of performing the second operation related to the first operation, the second operation can be smoothly performed.

An information processing method of an example embodiment of setting a displayed part in a display object on the basis of a user's operation includes: an operation information acquisition step of acquiring operation information according to the user's operation; a displayed part setting step that sets the displayed part to a first part on the basis of the operation information according to a first operation, and sets the displayed part to a second part on the basis of the operation information according to a second operation related to the first operation; and a display controlling step of displaying the part of the display object set by the displayed part setting step, wherein the displayed part setting step sets the displayed part at a first interval on the basis of the operation information according to the first operation, and sets the displayed part at a second interval different from the first interval on the basis of the operation information according to the second operation.

Also according to this configuration, the first operation is performed, thereby allowing the displayed part in the display object to be set to the first part at the first interval. The second operation related to the first operation is performed, thereby allowing the displayed part in the display object to be set to the second part at the second interval different from the first interval.

An information processing method of another example embodiment of setting a displayed part in a display object on the basis of a user's operation, includes: an operation information acquisition step of acquiring operation information according to the user's operation; a displayed part setting step that sets the displayed part to a first part on the basis of the operation information according to a first operation, and sets the displayed part to a second part on the basis of the operation information according to a second operation whose type is different from the first operation to an operation target identical to an operation target on which the first operation is performed; and a display controlling step of displaying the part of the display object set by the displayed part setting step, wherein the displayed part setting step sets the displayed part at a first interval on the basis of the operation information according to the first operation, and sets the displayed part at a second interval different from the first interval on the basis of the operation information according to the second operation.

Also according to this configuration, the first operation is performed to the operation target, thereby allowing the displayed part in the display object to be set to the first part at the first interval. The second operation is performed to the identical operation target, thereby allowing the displayed part in the display object to be set to the second part at the second interval different from the first interval. This configuration negates the need to perform the second operation to another operation target after the first operation. Even in the case of performing the second operation related to the first operation, the second operation can be smoothly performed.

An information processing system of an example embodiment includes: a display section displaying a part of a display object; an operation input section that detects a user's operation and outputs operation information according to the detected operation; an operation information acquisition section that acquires the operation information; a displayed part setting section that sets the displayed part on the display section to a first part on the basis of the operation information according to a first operation, and sets the displayed part on the display section to a second part on the basis of the operation information according to a second operation related to the first operation; and a display controller that displays the part of the display object set by the displayed part setting section, wherein the displayed part setting section sets the displayed part on the display section at a first interval on the basis of the operation information according to the first operation, and sets the displayed part on the display section at a second interval different from the first interval on the basis of the operation information according to the second operation.

Also according to this configuration, the first operation is performed, thereby allowing the displayed part in the display object to be set to the first part at the first interval. The second operation related to the first operation is performed, thereby allowing the displayed part in the display object to be set to the second part at the second interval different from the first interval.

An information processing system of another example embodiment includes: a display section displaying a part of a display object; an operation input section that detects a user's operation, and outputs operation information according to the detected operation; an operation information acquisition section that acquires the operation information; a displayed part setting section that sets the displayed part on the display section to a first part on the basis of the operation information according to a first operation, and sets the displayed part on the display section to a second part on the basis of the operation information according to a second operation whose type is different from the first operation to an operation target identical to an operation target on which the first operation is performed; and a display controller that displays the part of the display object set by the displayed part setting section, wherein the displayed part setting section sets the displayed part on the display section at a first interval on the basis of the operation information according to the first operation, and sets the displayed part on the display section at a second interval different from the first interval on the basis of the operation information according to the second operation.

Also according to this configuration, the first operation is performed to the operation target, thereby allowing the displayed part in the display object to be set to the first part at the first interval. The second operation is performed to the identical operation target, thereby allowing the displayed part in the display object to be set to the second part at the second interval different from the first interval. This configuration negates the need to perform the second operation to another operation target after the first operation. Even in the case of performing the second operation related to the first operation, the second operation can be smoothly performed.

These and other object, features, aspects and advantages of the present invention will become more apparent from the following detailed description of the present invention when taken in conjunction with the accompanying drawings.

### BRIEF DESCRIPTION OF THE DRAWINGS

FIG. 1 shows an example non-limiting of a configuration of an information processing system;

FIG. 2 shows an example non-limiting of a configuration of a display object;

FIG. 3A shows an example non-limiting of an operation of moving a part to be displayed on a display panel to one page succeeding or one page preceding part (in a state where a finger is in contact with a touch panel);

FIG. 3B shows an example non-limiting of an operation of moving a part to be displayed on the display panel to one page succeeding or one page preceding part (in the state where a drag operation has been performed);

FIG. 4 shows an example non-limiting of a display screen on which a plurality of pages are to be moved;

FIG. 5A shows an example non-limiting of a user's operation for causing a displayed part setting section to designate a chapter start part (a drag operation to a slider);

FIG. 5B shows an example non-limiting of a user's operation for causing the displayed part setting section to designate a chapter start part (a flick operation where the dragged slider is a starting point); and

FIG. 6 shows an example non-limiting of a flowchart of an operation of an information processing system.

### DETAILED DESCRIPTION OF THE PREFERRED EMBODIMENTS

An information processing system of an example embodiment displays a part of a display object. More specifically, a following information processing system displays a part of a display object and can set a part of the display object that is to be displayed.

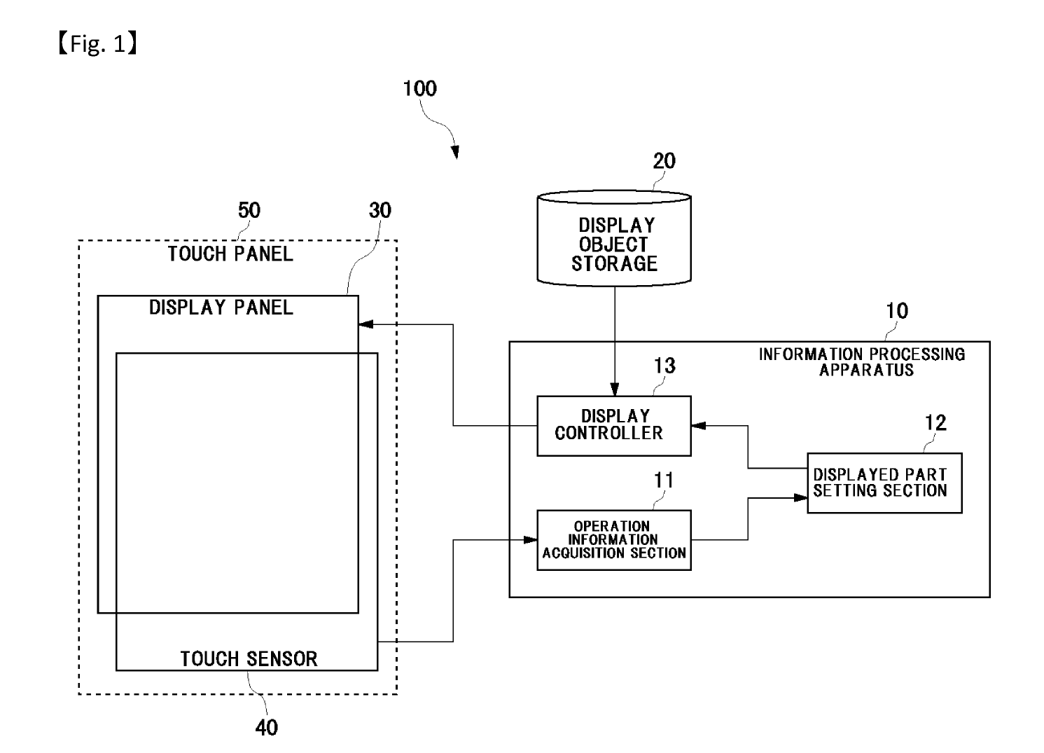

FIG. 1 shows an example non-limiting of a configuration of an information processing system. As shown in FIG. 1, the information processing system 100 includes an information processing apparatus 10, a display object storage 20, a display panel 30, and a touch sensor 40. The display panel 30 and the touch sensor 40 configure a touch panel 50.

The display object storage 20 stores a display object to be displayed using the display panel 30. In this embodiment, the display object storage 20 stores data of a book as a display object. The display object is a continuous display object. The number of characters included in a book is enormous. Accordingly, the entire content cannot be displayed on the display panel 30 at one time. The data of the book is displayed on display panel 30 part by part.

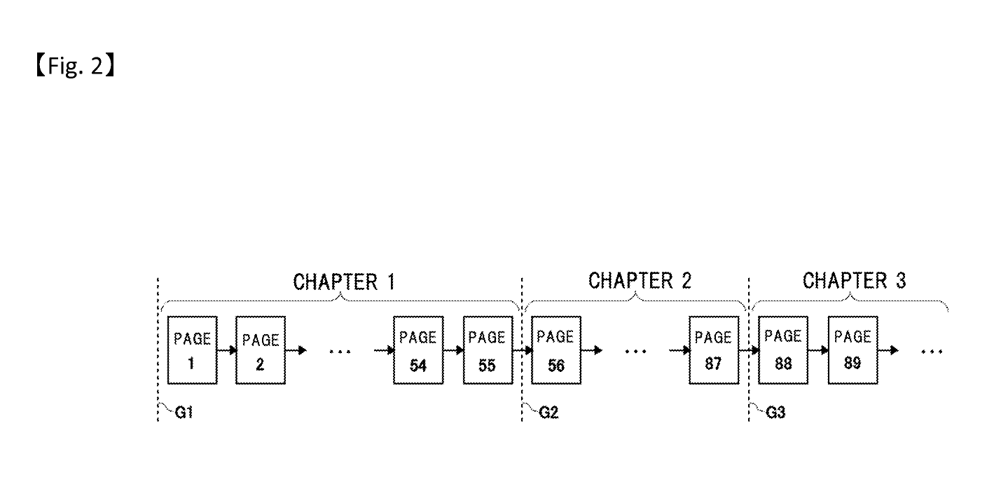

FIG. 2 shows an example non-limiting of a configuration of data of a book stored in the display object storage 20. As shown in FIG. 2, the data of a book is separated according to pages, and page numbers are assigned to respective pages. Thus, the entire display object of this embodiment (the entire data of the book) is separated into parts that can be displayed on the display panel 30 at one time, and the parts are continuous. The interval of the separation, i.e. one page, is also referred to as a “first interval”.

As shown in FIG. 2, the data of the book is separated into chapters each including a plurality of pages. Chapter numbers are assigned to the respective chapters. In the display object storage 20, grids are set on the top pages of the respective chapters. In the example in FIG. 2, pages 1 to 55 are in chapter 1, pages 56 to 87 are in chapter 2, and page 88 and thereafter are in chapter 3. Parts at grids G1, G2 and G3 are page 1 (chapter 1), page 56 (chapter 2), page 88 (chapter 3). The display object of this embodiment is thus separated into groups. Each group includes one part or a plurality of parts each of which can be displayed on the display panel 30 at one time. The grids are set on the top of the respective groups. The interval of the separation, i.e. one chapter, is also referred to as a “second interval”.

The respective intervals of separations corresponding to a “first interval” and a “second interval” in book data shown in FIG. 2 may be dynamically changed. For instance, the respective ranges of pages corresponding to the content of each page and each chapter may be set by setting the amount of data to be displayed on the display panel 30 by a user at one time, i.e. the number of characters in a page. According thereto, the number of pages in each chapter may be set.

The display panel 30 receives data of the display object from the information processing apparatus 10, and displays the data in a viewable manner. In this embodiment, the display panel 30 is a liquid crystal panel. However, the panel is not limited thereto, and may be another publicly-known display panel, such as an organic EL panel, that can display a display object.

The touch sensor 40 is provided on the surface of the display panel 30. In FIG. 1, the display panel 30 and the touch sensor 40 are overlapped with each other in a deviated manner. In actuality, the touch sensor 40 is covered on the entire surface of the display panel 30. The touch panel 50 is configured by covering the display panel 30 with the touch sensor 40. The touch sensor 40 may be configured so as to cover only a part of the display panel 30.

The touch sensor 40 receives an input of a user's operation, converts the input into an operation input signal as operation information, and provides the signal for the information processing apparatus 10. In this embodiment, the touch sensor 40 is a capacitive touch sensor that can sense a contact by a finger. However, the sensor is not limited thereto. Instead, the sensor may be another publicly-known touch sensor, such as a pressure-sensitive or electromagnetically inductive touch sensor. An operation to the touch sensor 40 may be performed by a finger or an appliance, such as a stylus pen.

The touch sensor 40 may be replaced with another operation input means that can designate any position on the display screen and input an operation. For instance, the sensor may be replaced with a configuration in which a pointer displayed on the screen of the display panel 30 is operated by a mouse, a touch pad, a lever or the like. The touch sensor 40 of this embodiment senses a position at which a finger is contact at a prescribed sampling period, and outputs an operation input signal indicating the position to the information processing apparatus 10.

The information processing apparatus 10 is connected to the display object storage 20, the display panel 30 and the touch sensor 40. The information processing apparatus 10 designates a part of the display object that is to be displayed, from the display object storage 20 (hereinafter, simply referred to as a “displayed part”), reads the displayed part, and displays the displayed part on the display panel 30. The information processing apparatus 10 receives the operation input signal from the touch sensor 40, and performs various processes according to the operation input signal.

The information processing apparatus 10 includes an operation information acquisition section 11, a displayed part setting section 12, and a display controller 13. The information processing apparatus 10 executes a computer program of an example embodiment to thereby realize each of such sections. The computer program is supplied to a computer in a manner stored in a storage medium. The computer reads the computer program from the storage medium and executes the program.

The operation information acquisition section 11 acquires an operation input signal as operation information from the touch sensor 40. The operation information acquisition section 11 acquires an operation input signal from the touch sensor 40 at a prescribed sampling period. The operation information acquisition section 11 outputs the acquired operation input signal to the displayed part setting section 12.

The displayed part setting section 12 sets a part of the display object that is to be displayed on the display panel 30, on the basis of the operation information input from the operation information acquisition section 11. Accordingly, the displayed part setting section 12 analyzes the content of the operation performed by a user to the touch sensor 40, on the basis of the operation input signal acquired by the operation information acquisition section 11.

The operations performed by the user to the touch sensor 40 are herein described. The operations performed by the user to the touch sensor 40 include a tap operation, a slide operation, and a flick operation. In this embodiment, the tap operation is an operation where a finger comes into contact with the touch sensor 40, the finger does not move on the touch sensor 40 and the finger is removed from the touch sensor 40 in a prescribed time.

In this embodiment, the slide operation is an operation where a finger comes into contact with the touch sensor 40, and the finger moves on the touch sensor 40 as it is. The slide operations include an operation where a finger moves as if drawing any shape on the touch sensor 40, and an operation where a finger comes into contact with a site at which an operation target is displayed and the finger moves to drag the operation target (drag operation).

In this embodiment, as with the slide operation, the flick operation is an operation where a finger comes into contact with the touch sensor 40, the finger moves on the touch sensor 40 as it is at a prescribed speed or higher, and the finger is removed from the touch sensor 40 without stopping the movement. In this embodiment, the flick operation is recognized separately from the slide operation.

The types of operations to the touch sensor 40 are not limited to the above types. Definitions of various operations are not limited to the above details. For instance, in a system incapable of recognizing a long press, the definition of a tap does not necessarily require removal of a finger in a prescribed time.

The displayed part setting section 12 detects the position in the display screen, the movement amount, the movement speed, the movement direction, and the type of performed operation of the finger in contact with the touch sensor 40, on the basis of the operation input signal and the history thereof. Here, the movement amount is a length along which a finger moves on the touch sensor 40 after the finger comes into contact with the touch panel until the finger is removed. The movement speed is acquired by dividing the movement distance therebetween by the movement time at every prescribed time or movement amount.

The displayed part setting section 12 sets the displayed part in the entire display object stored in the display object storage 20, on the basis of the detected result. More specifically, the displayed part setting section 12 sets a page to be displayed, on the data of a book shown in FIG. 2. The setting by the displayed part setting section 12 is output to the display controller 13.

The display controller 13 reads the display part set by the displayed part setting section 12 from the display object storage 20. The read part is output to the display panel 30, thereby causing the display panel 30 to display the displayed part.

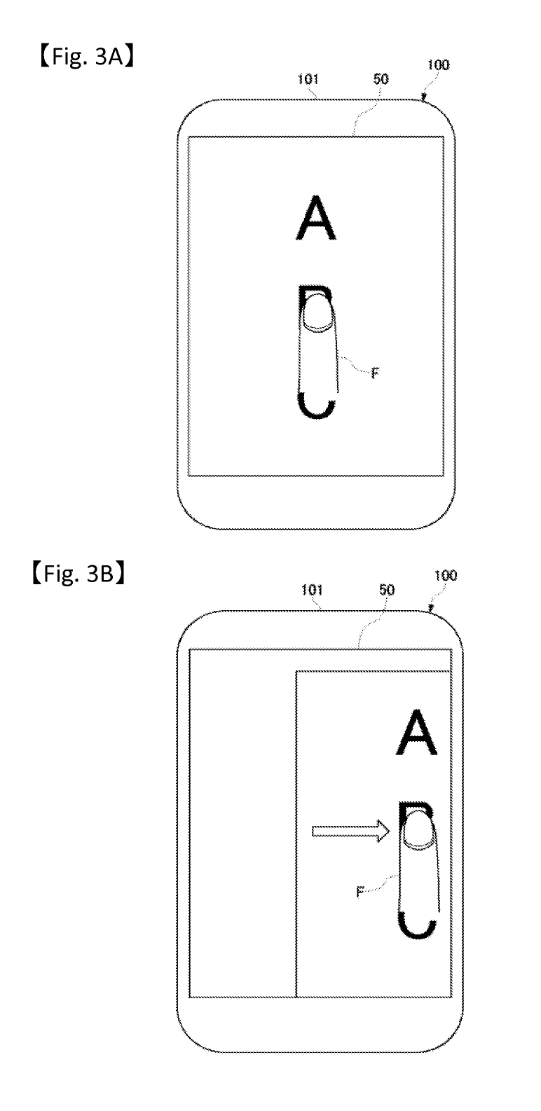

FIG. 3 shows an example non-limiting of an operation of moving the displayed part to one page succeeding or preceding part. In FIG. 3, the information processing system 100 of this embodiment includes a casing 101 and the touch panel 50 exposed from the casing 101. FIG. 3A shows a state where a finger F is in contact with the touch panel 50. FIG. 3B shows a state where the finger F has moved in the right direction while being in contact with the touch panel 50, from the state of FIG. 3A (drag operation).

After the finger F has moved from the state shown in FIG. 3A, the displayed part setting section 12 detects the movement amount of the finger F. In the case where the finger F has moved from the state shown in FIG. 3A to the state shown in FIG. 3B and the movement amount at this time exceeds a prescribed threshold, the displayed part setting section 12 sets a page one page succeeding this page (a page prepared on the left side) as the displayed part. Thus, in the case where a drag operation whose lateral movement amount exceeding a prescribed threshold is performed on a displayed part in the display object in the display screen, the displayed part setting section 12 sets a page succeeding by one page or preceding by one page as the displayed part.

The drag operation for moving the displayed part by one page is not necessarily in a strict horizontal direction. For instance, in the case where the horizontal directional component of the drag operation exceeds a prescribed threshold only on the basis of the horizontal directional component, the displayed part may be moved by one page, and, in the case where the horizontal directional component of the drag operation exceeds a prescribed threshold and the ratio of the horizontal directional component to the vertical directional component is not less than a certain amount (i.e., the deviation in angle from the horizontal direction is within a certain amount), the displayed part may be moved by one page.

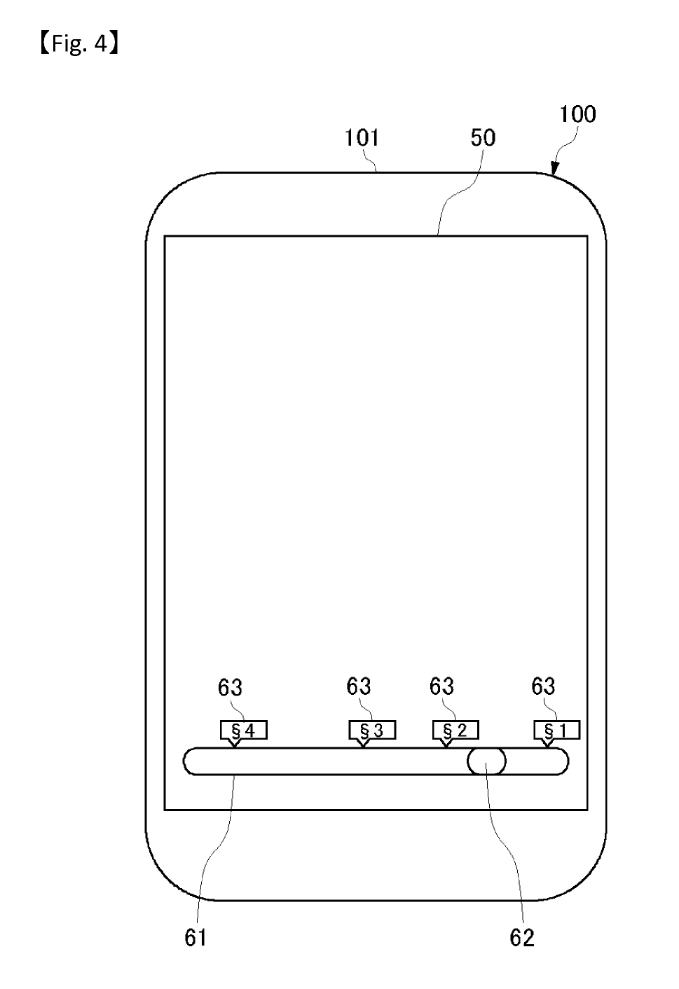

FIG. 4 shows an example non-limiting of the display screen for moving by a plurality of pages. When a tap is detected in a prescribed region below the display screen of the touch panel 50 as detected results, such as the position in the display screen, the movement amount, the movement speed, the movement direction and the type of performed operation of the finger in contact, the displayed part setting section 12 displays a scroll bar 61 and a slider 62 movable along the scroll bar 61 are displayed as operation targets at the bottom of the display screen as shown in FIG. 4. In this embodiment, the scroll bar 61 and the slider 62 as the operation targets appear in the display screen according to a prescribed operation that is a tap in the prescribed region below the display screen. Instead, the operation target may be always displayed in the case of displaying the display object.

The scroll bar 61 laterally extends. The slider 62 is laterally movable along the scroll bar 61. The user can move the slider 62 along the scroll bar 61 by causing a finger to drag the slider 62. The entire length of the scroll bar 61 corresponds to the entire display object. For instance, in the case where the book includes 200 pages, the right end of the scroll bar 61 corresponds to page 1 and the left end of the scroll bar 61 corresponds to page 200.

The slider 62 may be movable to a position by directly indicating the position of the scroll bar 61 to which the slider 62 is to be moved (contact by a finger). Instead of combination of the scroll bar 61 and the slider 62, only a range bar whose entire length corresponds to the entire display object may be displayed and a finger may come into contact with a position of the range bar corresponding to a desired destination to thereby move the displayed part to the position corresponding to the position of contact. Note that, without displaying the scroll bar, the slider or the range bar, a part to be displayed may be set by touching any part of the screen and dragging.

As described above, the pages of the book are separated into the groups (chapters). Along the scroll bar 61, chapter start part marks 63 are displayed at the positions corresponding to the start parts (tops) of the respective groups (chapters). In the example of FIG. 4, the scroll bar 61 and the slider 62 indicate that the currently displayed part is on a certain page in the latter half of chapter 1.

In the case where the user intends to move the displayed part by several tens or several hundreds of pages instead of one page or several pages when reading the book, the user touches a bottom part of the display screen to display an operation target including the scroll bar 61 and the slider 62 as shown in FIG. 4 and moves the slider 62 by a drag operation, thereby moving the displayed part to a desired part in the display object.

In the case where a drag of the slider 62 is detected on the basis of detected results, such as the position in the display screen, the movement amount, the movement speed, the movement direction, and the type of the performed operation of the finger in contact, the displayed part setting section 12 displays the page corresponding to the position of the destination of the slider 62. More specifically, the displayed part setting section 12 designates the page corresponding to a position of the finger F when the finger F is removed from the touch panel 50 (i.e., the position of the dragged slider 62).

For instance, as shown in FIG. 4, in the case where the user intends to move to chapter 3 when reading the middle of chapter 1, the user can move the slider 62 to the chapter start part mark of chapter 3. However, even though the chapter start part marks 63 of the respective chapters are displayed, the movement amount of the slider 62 corresponding to one page of the book is significantly small. Accordingly, it is sometimes difficult to move the slider 62 just to the start part of chapter 3.

Thus, in this embodiment, a second operation, which is a type different from the first operation and related to the first operation and moves the slider 62 to the target chapter start part along the scroll bar 61, is performed (the second operation is performed subsequently to the first operation), thereby allowing movement to the start part of the chapter as the destination. More specifically, in the case where a flick operation in the vertical direction is performed as the second operation subsequently to the movement of the slider 62, the displayed part setting section 12 sets the page as the designated destination to the chapter start part. The chapter start part is a part where a grid is set as the second interval, and also referred to as “second part”. Each page is also referred to as a “first part”.

In the case of detecting a drag of the slider 62 and detecting a flick in the vertical direction subsequent to the drag on the basis of the detected results, such as the position in the display screen, the movement amount, the movement speed, the movement direction and the type of the performed operation of the finger in contact, and the case where the base point (the end point of the drag) of the flick is in a prescribed region centered on the chapter start part mark 63, the displayed part setting section 12 displays the page at the chapter start part indicated by the chapter start part mark. Note that the page of the chapter start part may be displayed only by the flick operation without the drag operation.

The first operation is not limited to a drag of the slider 62. For instance, the finger may come into contact with any position on the scroll bar, thereby allowing the slider 62 to move to the position. In the case where the displayed part is intended to move to the chapter start part, the finger can come into contact with proximity to the chapter start part mark of the chapter concerned (first operation) and a flick operation (second operation) can be performed in the vertical direction as it is.

The displayed part setting section 12 sets the displayed part, and, for instance, causes the display controller 13 to display the scroll bar 61, the slider 62 and the chapter start part mark 63 that are operation targets, and issues an instruction for moving the slider 62 in response to the operation. The position in the display screen, the movement amount, the movement speed, the movement direction, and the type of the performed operation of the finger in contact with the touch sensor 40 are detected on the basis of the operation information acquired from the operation information acquisition section 11; the instruction on the operation target is issued on the basis of the detected results. Note that the displayed part setting section 12 for displaying the chapter start part mark 63 is also referred to as a “mark provider”.

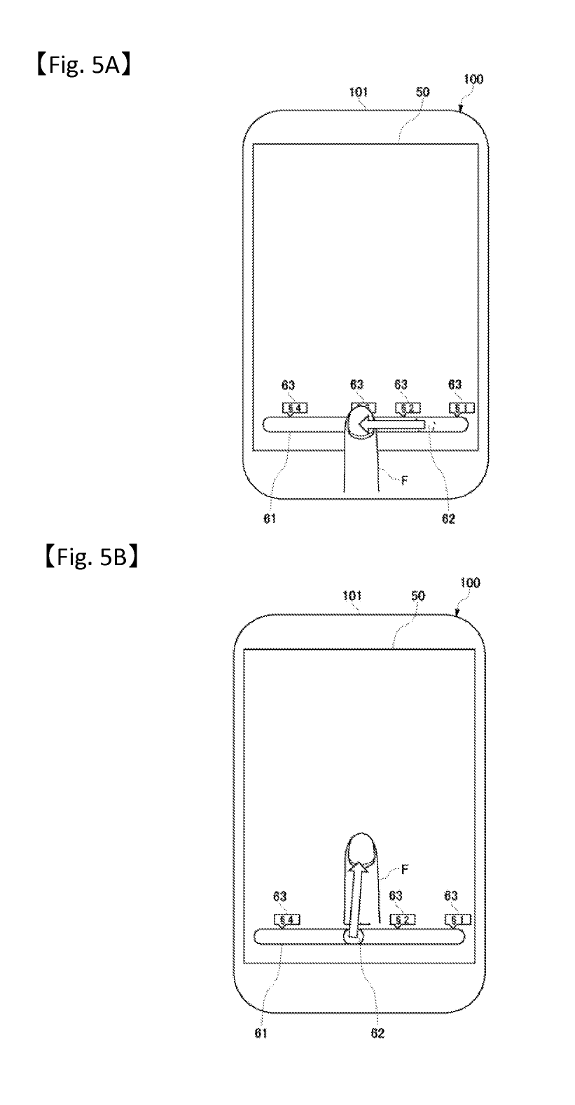

FIG. 5 shows an example non-limiting of a user's operation for designating the chapter start part by the displayed part setting section 12. FIG. 5A shows a drag operation to the slider. FIG. 5B shows a flick operation where the dragged slider is the starting point. In the case where the user intends to move the top of chapter 3 when reading the middle of chapter 1, the user moves the slider 62 to proximity to the chapter start part mark 63 of chapter 3 as shown in FIG. 5A and subsequently performs a flick operation in the upper direction as shown in FIG. 5B without departing the finger F from the touch panel 50 as it is.

The displayed part setting section 12 then detects the drag operation and the subsequent flick operation, and sets the displayed part to the first page of chapter 3 at which the grid is set. At this time, the displayed part setting section 12 detects that the starting point of the flick operation is in a prescribed range set centered on the position indicated by the chapter start part mark 63 of chapter 3, and sets the displayed part to the first page of chapter 3. In the case where the starting point of the flick operation subsequent to the drag operation exceeds the range set centered on the position indicated by the chapter start part mark 63 of chapter 3, even if the flick operation is detected, the displayed part setting section 12 sets, to the displayed part, not the first page of the chapter but the part of the display object corresponding to the position of the slider that is the starting point of the flick operation.

For instance, as to chapter 3, the region in which a flick operation for moving to the chapter start part is detected may be from a prescribed part after chapter 2 to chapter 3 (i.e. the right side of chapter 3) or from chapter 3 to a prescribed part before chapter 4 (i.e. the left side of chapter 3).

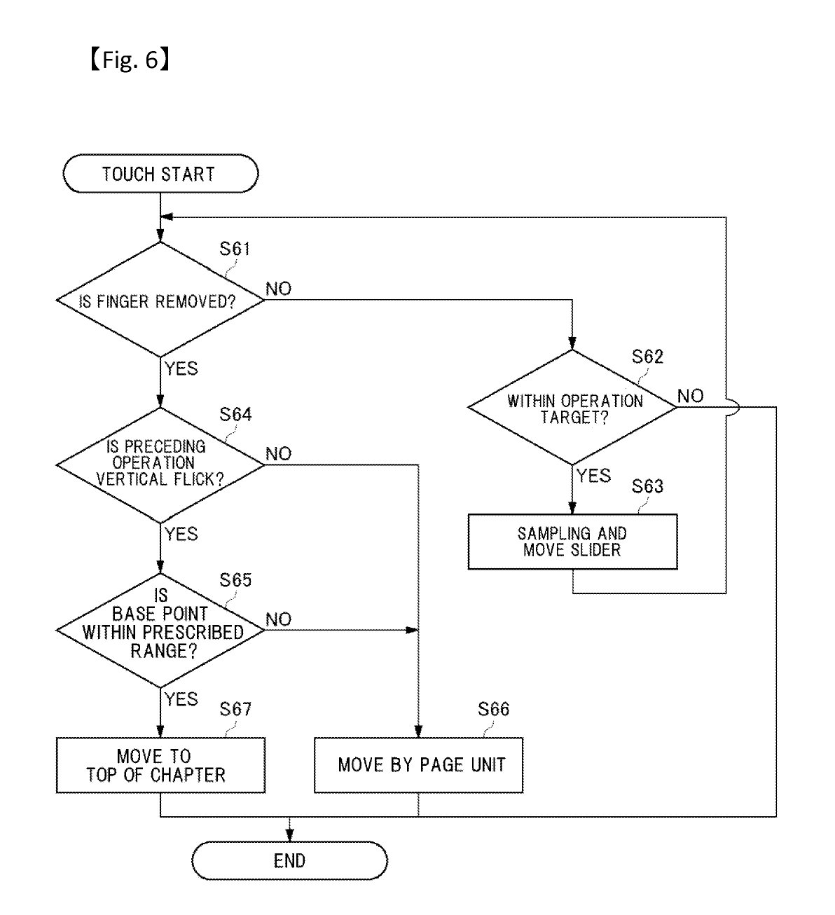

An operation of the information processing system 100 configured as described above will be described. FIG. 6 shows an example non-limiting of a flowchart of an operation of the information processing system 100. In particular, FIG. 6 shows a case of moving by a plurality of pages (i.e., movement to any part in the display object). A process according to the flowchart of FIG. 6 starts when a finger of the user comes into contact with the touch sensor 40.

The displayed part setting section 12 determines whether the finger of the user is removed from the touch panel 50 or not on the basis of an input operation signal from the touch sensor 40 (step S61). In the case where the finger is not removed, the displayed part setting section 12 determines whether the position of the finger is within an operation range centered on the operation target or not (step S62). This is determination for not moving the displayed part in the case where the slider 62 is dragged, the position of the slider 62 is set and then the finger is not removed from the touch panel 50 as it is and goes out of the operation region. Accordingly, in the case where the position of the finger of the user largely deviates from the operated object and exceeds the operation region (NO in step S62), the processing is finished.

In the case where the finger is within the operation region (YES in step S62), the displayed part setting section 12 samples the position of the finger and the slider 62 is moved to the position corresponding to the position of the finger (step S63) and the processing returns to step S61.

In the case where the finger is removed from the touch panel 50 (YES in step S61), the displayed part setting section 12 determines whether the preceding operation is a flick operation in the vertical direction or not (step S64). In the case where the preceding operation is not the flick in the vertical direction (NO in step S64), the displayed part is moved to the page corresponding to the position of the finger (the position of the slider) when the finger is removed from the touch panel 50 (step S66) and the processing is finished.

In the case where the operation immediately before removal of the finger from the touch panel 50 is the flick in the vertical direction (YES in step S64), the displayed part setting section 12 determines whether the base point of the flick operation is within a prescribed region centered on the chapter start part mark or not (step S65). In the case where the base point is not within the region (NO in step S65), the displayed part setting section 12 sets, as the displayed part, the page corresponding to the position of the finger (the position of the slider) when the finger is removed from the touch panel 50, and the display controller 13 causes the display panel 30 to display the designated page (step S66) and the processing is finished.

That is, in the case where the user drags the slider 62 and subsequently removes the finger from the touch panel 50 and the case where the user drags the slider 62 and subsequently performs a flick operation at a position apart from the chapter start part mark 63, the displayed part is moved to a page corresponding to the position of the finger when the finger is removed from the touch panel 50.

In the case where the base point of the flick operation is within a prescribed region centered on the chapter start part mark (YES in step S65), the displayed part setting section 12 sets the page of the top of the corresponding chapter as the displayed part, and the display controller 13 causes the display panel 30 to display the set page (step S67), and the processing is finished. More specifically, the displayed part setting section 12 moves the displayed part to the chapter start part (the page at which the grid is set at the second interval) corresponding to the position of the base point of the flick. That is, after the drag operation of the slider 62, the flick operation is subsequently performed in the vertical direction around the chapter start part mark 63, and the displayed part is moved to the page at the top of the chapter, irrespective of the strict position when the slider 62 is moved, in other words, even without correctly matching the part to be displayed when the slider 62 is moved with the chapter start part.

As described above, according to the information processing system 100 of this embodiment, movement of the slider as the first operation allows the displayed part to move to any page, and, a flick operation in the upward direction as the second operation, which is subsequent to the slider movement as the first operation, allows the displayed part to move to any of parts set at chapters each including pages.

Each of the first operation and the second operation is an operation to the identical operation target, which is the slider 62. Accordingly, the second operation subsequent to the first operation can be smoothly performed.

Along the scroll bar 61, the tops of respective chapters are set at the second intervals. According to the information processing system 100 of this embodiment, in the case where the second operation subsequent to the first operation is performed, the displayed part is moved to the top (the part set at the second interval) of the chapter nearest the slider having been moved by the first operation. Accordingly, the display object displayed on the display panel 30 can be moved to the top of the chapter intended by the user.

Furthermore, along the scroll bar 61, the chapter start part marks 63 are indicated at the positions corresponding to the tops of the respective chapters. Accordingly, the user can correctly grasp to which the first operation is performed and at which the second operation is performed, and more securely move the display object displayed on the display panel 30 to the desired chapter.

In the above embodiment, around the chapter start part mark 63 for each chapter, the region for detecting the flick operation (second operation) for controlling movement to the top of the chapter is set. In the case where a flick operation (second operation) subsequent to a drag operation (first operation) to the slider 62 is detected in the region, the displayed part is moved to the top of the chapter concerned. However, such a region is not necessarily configured. In this case, for instance, when a flick operation subsequent to a drag operation is detected, the displayed part may be moved to the chapter start part nearest the base point of the flick operation, to the right chapter start part with respect to the base point of the flick operation, or to the left chapter start part with respect to the base point of the flick operation.

In the above embodiment, in the case where the flick determination is NO when the flick operation is performed subsequent to the drag operation, the page corresponding to the part at which the finger is removed from the touch panel is set as the displayed part. In such a case, the page corresponding to the end part of the drag operation may be set as the displayed part. In this case, if an operation exceeding a threshold of the vertical component is performed in step S64 in FIG. 6, it is determined that the flick operation has started, and, in step S66, the preceding part is regarded as the end part of the drag operation, and the page corresponding to this part is set as the displayed part.

In the above embodiment, the chapter start part mark 63 indicating the respective chapter start parts are displayed in association with the scroll bar 61. However, the marks are not necessarily displayed. In this case, without providing the mark of the chapter start part, it is difficult to perform the flick operation around the chapter start part. Accordingly, a specification should be adopted where a flick operation at any part allows movement to the nearest chapter start part. Thus, the region for detecting a flick operation is not configured.

In the above embodiment, the display object may be separated into groups at third intervals, which are wider than the second intervals, and a third operation subsequent to the second operation may allow movement at the third interval.

In the above embodiment, the example where the second interval is larger than the first interval has been described. The first interval may be larger than second interval.

In the above embodiment, the data of the book has been exemplified as the display object. However, the display object is not limited thereto. The display object may be anything that is displayed on the display panel 30 by each part thereof. The display object may be, for instance, plurality of images sequentially arranged according to imaging time. In this case, the first interval may be configured for each image. For instance, the second interval may be configured at each imaging year. In this case, the first operation allows the image displayed on the display panel 30 to move to any image among the images as the display object, and the second operation subsequent to the first operation allows movement to the first image in each year. Furthermore, the above description has exemplified, as the display object, the continuous display object, such as the data of the book or the plurality of sequentially arranged images. However, the display object may be an object that is not continuous.

In the case where the display object is a plurality of images, a part of the display object displayed on the display panel 30 may be a thumbnail display image including a plurality of thumbnail images.

In the case where the display object is a plurality of images, the arrangement sequence may be any arrangement sequence designated by the user. The groups separated by the second interval may be arbitrarily designated by the user. Furthermore, attribute information added to the images may be regarded. For instance, in the case where a plurality of images of game character cards are the display objects, groups may be separated by the second intervals on the basis of attributes of the characters. The attributes are added to the image data. The attributes may be automatically grouped. Instead, the user may determine the attributes and manually group the attributes.

In the above embodiment, the scroll bar 61 and the slider 62 are displayed as operation targets, and an operation is performed thereon for moving by a plurality of pages. However, the scroll bar or the like is not necessarily displayed. Instead, the display object itself may be regarded as an operation target, and directly dragging the display object may move a plurality of pages.

Furthermore, in the above embodiment, the interval of the display object displayed on the display panel 30 at one time (each page) is identical to the first interval that is a part moved by the first operation. However, these are not necessarily identical. For instance, in the case where a book includes 800 pages and the number of steps of movement of the slider 62 along the scroll bar 61 is 400, one step of the slider 62 moves two pages. That is, the first interval is two pages.

As already apparent in the above description, the second interval is not necessarily set at equal intervals. Furthermore, the first interval is not necessarily set at equal intervals. For instance, in the case where the book includes 600 pages and the number of steps of movement of the slider 62 along the scroll bar 61 is 400, one step may move one page and the next one step may move two pages and these movements may be alternately repeated. That is, the first interval may be set such as one page, two pages, one page, two pages . . . .

The first interval at which movement is performed by the first operation may be smaller than the interval of the display object on the display panel 30 at one time (each page). For instance, a double page spread (two pages) may be displayed on the display panel, and the first interval may be an interval of one page. In this case, for instance, if the first and second pages are displayed, movement at the first interval to the one subsequent displayed part displays page 2 and page 3.

In the above embodiment, the operation target to which the first operation and the second operation are performed is the slider 62 that moves along the scroll bar 61. The first operation is the operation of moving the slider 62. The second operation subsequent thereto is the flick operation in the vertical direction where the moved slider 62 is the starting point. However, the first operation and the related second operation are not limited thereto. Hereinafter, various examples other than the above first operation and the above related second operation will be described.

### Operation Example 1

As with the above embodiment, in this example, the scroll bar 61 and the slider 62 moving therealong are operation targets. As the above embodiment, the first operation is an operation moving the slider 62 along the scroll bar 61. In this operation example, the second operation related to the first operation is an operation that is subsequent to movement of the slider 62 as the first operation and moves the finger on the touch panel 50 so as to draw a circle whose starting point is the moved slider 62 without removing the finger from the touch panel 50.

As a further variation, the second operation may be an operation that slides the finger on the touch panel 50 so as to draw a check mark whose starting point is the moved slider 62 (movement to the bottom end and subsequent upward movement forming an acute angle), and an operation that moves the slider 62 and subsequently removes the finger from the touch panel 50 and causes the finger to come into contact again at the position (drag and tap).

### Operation Example 2

In the above embodiment, to move the page to the one page preceding or succeeding page of the book, the page displayed on the display panel 30 is slid. In this operation example, movement of a plurality of pages is likewise performed by an operation to the page displayed on the display panel 30. However, in the case of movement by a plurality of pages, a flick operation is performed onto the displayed page.

The displayed part setting section 12 sets the part to be displayed according to the flick operation as the first operation from the page displayed on the display panel 30. That is, the larger the amount of movement of the finger in the flick operation and the higher the speed is, the longer the displayed part setting section 12 sets the movement distance from the currently displayed page.

The displayed part setting section 12 detects the flick operation in the lateral direction to the displayed page and the movement amount (length) and the speed on the basis of the operation input signal acquired by the operation information acquisition section 11. The larger the movement amount is and the higher the speed is, the farther the page from the displayed page is set as the displayed part. Instead of preliminarily designating the part to be displayed, the speed may be gradually decreased and may be stopped at a part where the speed becomes zero.

Upon receiving the setting of the displayed part from the displayed part setting section 12, the display controller 13 sequentially performs the display feeding operation from the currently displayed page to the set part (page). That is, on the display panel 30, the page is switched sequentially from the currently displayed page to the displayed part set by the displayed part setting section 12. The page switching on the display panel 30 is performed after the flick operation is performed and the finger is departed from the touch panel 50. Such a display feeding operation and page switching are referred to as an inertial display feeding operation.

The inertial display feeding operation by the flick operation may be repeatedly performed. That is, in the middle where the inertial display feeding operation is being performed and switching of the page displayed on the display panel 30 is being performed, a further flick operation in the same direction further performs the inertial display feeding operation on the basis of the page displayed on the display panel 30 at that time. Thus, in the case of repeatedly performing the flick operation (i.e. the first operation is consecutively performed), the displayed part setting section 12 may sets the displayed part farther in an accelerated manner.

Such a flick operation corresponds to the first operation. The second operation related to the first operation is a tap operation performed on the touch panel 50 in the middle of the inertial display feeding operation (flick and tap operation) is being performed. That is, when a tap operation is performed on the touch panel 50 during the inertial display feeding operation, the tap operation is regarded as the second operation related to the first operation and the displayed part setting section 12 sets, as the displayed part, the part (the top of the chapter) set at the second interval nearest the part displayed on the display panel 30 when the tap operation is performed with reference to this part.

As to a further variation, the displayed part setting section 12 may set, as the displayed part, the part (the top of the chapter) set at the second interval nearest the reference part in the advance direction with reference to this reference part displayed on the display panel 30 when the tap operation is performed, or designate, as the displayed part, the part (the top of the chapter) set at the second interval nearest the reference part in the backward direction. The second operation may be any of other operations, such as a double tap operation, a flick operation in the reversed direction, and a flick operation in the vertical direction.

### Operation example 3

In the above embodiment, the information processing system 100 includes the touch sensor 40, input of a user's operation is performed on the touch sensor 40, and the operation information is detected by the touch sensor 40. However, means for detecting a user's operation is not limited to the touch sensor 40. For instance, the means may be operation input elements, such as a button and a lever, or a gyro sensor.

In the cases of performing an operation to input operation elements, such as a button and a lever, the scroll bar and the slider are displayed on the display panel 30 and the displayed part setting section 12 regards the operation of moving the slider by the operation to the input operation element as the first operation and regards the second operation performed within a prescribed time (e.g. 0.5 second) after the first operation as the second operation subsequent to the first operation and designates the displayed part to the part set at the second interval (the top of the chapter).

The first operation may be, for instance, a press on the button in lateral direction for moving the slider in the lateral direction or a tilt of the lever in the lateral direction. The second operation may be, for instance, a press on the button in the upward direction or a tilt of the lever in the upward direction. Also in this case, the operation target is the slider, the operation target of the first operation and the operation target of the second operation are identical to each other.

In the case where the a gyro sensor detects an operation, for instance, the gyro sensor is included in the information processing system 100, the gyro sensor detects the tilt of the information processing system 100, converts the tilt into an operation input signal, and outputs the signal to the operation information acquisition section 11. In this operation example, a tilt of the information processing system 100 in the lateral direction performs the display feeding operation.

The displayed part setting section 12 sets the displayed part from the page displayed on the display panel 30 according to an angle of the tilt of the information processing system 100 and time of the tilt. The display controller 13 performs the display feeding operation sequentially by one page from the currently displayed page to the page set by the displayed part setting section 12. The tilt in the lateral direction corresponds to the first operation.

If the second operation is performed in the middle of the display feeding operation by the first operation, the displayed part setting section 12 regards the second operation as the second operation related to the first operation, and sets, as the displayed part, the part (the top of the chapter) set at the second interval. The second operation is, for instance, an operation of tilting the information processing system 100 in the vertical direction, and an operation swinging it in the forward and backward directions. In this operation example, the operation targets of the first and second operations are identical to each other; the target is the information processing system 100.

As described above, various modes can be considered as the first operation and the second operation subsequent thereto. There are various modes other than the above described operations, as the first operation and the second operation related (subsequent) thereto as the embodiment.

The above embodiment has exemplified, as the display object, the data of the book separated into a plurality of pages, images themselves, or images displayed as thumbnails. Each of these examples is one-dimensionally continuous display object. That is, the displayed part is set only in the forward and backward directions. However, the display object may be continuous in two or more dimensions.

For instance, the display object may be map data. The map data is continuous in two dimensional directions, and only a part of the data is displayed. In the case of the map data, the first interval is a minimum unit capable of moving the part to be displayed on the display panel. That is, as described above, the interval (each page) of the object to be displayed on the display panel 30 at one time may be different from the first interval that is to be the part moved by the first operation. In the case of the map data, the part displayed on the display panel 30 can be slightly moved. The first interval does not match with the size of the part displayed on the display panel 30.

In the case where the display object is the map data, the first operation may be the flick operation to the displayed map. The second operation subsequent to the first operation may be a tap operation performed in the middle of the inertial display feeding operation by the flick operation.

The information processing system 100 may be configured as a separate apparatus including all the elements shown in FIG. 1. Instead, a part thereof may be connected to another element via a transmission line or a network and data can be mutually transmitted and received. A part of the elements of the information processing apparatus 10 may be connected to another element via a data transmission line or a network and data can be mutually transmitted and received. Here, a part or the entire parts of the network may be a wireless network. In order to allow each of distributed elements to communicate with another part, a communication interface may be provided. For instance, the information processing system 100 may be a configuration where a terminal integrally including the touch panel 50 and the information processing apparatus 10 is connected to the display object storage 20 via a wireless network, the displayed part is downloaded from the display object storage 20 each time when the terminal performs the display feeding operation.

While non-limiting example embodiments have been described in detail, the foregoing description is in all aspects illustrative and not restrictive. It will be understood that numerous other modifications and variations can be devised.

What is claimed is:

1. A storage medium storing an information processing program causing a computer of an information processing apparatus setting a displayed part in a display object on the basis of a user's operation to function as:
an operation information acquisition section that acquires operation information according to the user's operation;
a displayed part setting section that sets the displayed part to a first part on the basis of the operation information according to a first operation, and sets the displayed part to a second part on the basis of the operation information according to a second operation related to the first operation; and
a display controller that displays the part of the display object set by the displayed part setting section,
wherein the displayed part setting section sets the displayed part at a first interval on the basis of the operation information according to the first operation, and sets the displayed part at a second interval different from the first interval on the basis of the operation information according to the second operation.

2. The storage medium according to claim 1, wherein the second interval is larger than the first interval.

3. The storage medium according to claim 1, wherein the first operation and the second operation are types of operations different from each other to an identical operation target.

4. The storage medium according to claim 1, wherein the second operation is an operation performed subsequently to the first operation.

5. The storage medium according to claim 3, wherein the first operation is an operation moving a slider along a scroll bar corresponding to the entire display object, and the second operation related to the first operation is an operation performed to the slider after the slider is moved along the scroll bar.

6. The storage medium according to claim 3, wherein the second operation related to the first operation is a gesture operation.

7. The storage medium according to claim 5, further causing the computer to function as a mark provider providing marks that are associated with the scroll bar and indicate positions set at the second interval.

8. The storage medium according to claim 1, wherein the first operation and the second operation are operations whose operation directions are different from each other.

9. The storage medium according to claim 1,
wherein the first operation is an operation to a displayed part of the display object,
the displayed part setting section sets the displayed part on the basis of the operation information according to the first operation,
the display controller sets the displayed part in a part of the display object set by the displayed part setting section, continuously even after completion of the first operation according to an amount and/or a speed of the first operation, and
the second operation is an operation set when the displayed part is being set by the display controller.

10. The storage medium according to claim 1, wherein the displayed part setting section sets the displayed part to a part displayed at a second interval having a certain relationship with the part displayed at the first interval based on the first operation on the basis of the operation information according to a second operation subsequent to the first operation.

11. The storage medium according to claim 10, wherein the displayed part setting section sets the displayed part to a part displayed at the second interval near a part displayed at the first interval based on the first operation on the basis of the operation information according to the second operation subsequent to the first operation.

12. A storage medium storing an information processing program causing a computer of an information processing apparatus setting a displayed part in a display object on the basis of a user's operation to function as:
an operation information acquisition section that acquires operation information according to the user's operation;
a displayed part setting section that sets the displayed part to a first part on the basis of the operation information according to a first operation, and sets the displayed part to a second part on the basis of the operation information according to a second operation whose type is different from the first operation to an operation target identical to an operation target on which the first operation is performed; and
a display controller that displays the part of the display object set by the displayed part setting section,
wherein the displayed part setting section sets the displayed part at a first interval on the basis of the operation information according to the first operation, and sets the displayed part at a second interval different from the first interval on the basis of the operation information according to the second operation.

13. An information processing apparatus setting a displayed part in a display object on the basis of a user's operation, comprising:
an operation information acquisition section that acquires operation information according to the user's operation;
a displayed part setting section that sets the displayed part to a first part on the basis of the operation information according to a first operation, and sets the displayed part to a second part on the basis of the operation information according to a second operation related to the first operation; and
a display controller that displays the part of the display object set by the displayed part setting section,
wherein the displayed part setting section sets the displayed part at a first interval on the basis of the operation information according to the first operation, and sets the displayed part at a second interval different from the first interval on the basis of the operation information according to the second operation.

14. An information processing apparatus setting a displayed part in a display object on the basis of a user's operation, comprising:
an operation information acquisition section that acquires operation information according to the user's operation;
a displayed part setting section that sets the displayed part to a first part on the basis of the operation information according to a first operation, and sets the displayed part to a second part on the basis of the operation information according to a second operation whose type is different from the first operation to an operation target identical to an operation target on which the first operation is performed; and
a display controller that displays the part of the display object set by the displayed part setting section,
wherein the displayed part setting section sets the displayed part at a first interval on the basis of the operation information according to the first operation, and sets the displayed part at a second interval different from the first interval on the basis of the operation information according to the second operation.

15. An information processing method of setting a displayed part in a display object on the basis of a user's operation, comprising:
an operation information acquisition step of acquiring operation information according to the user's operation;
a displayed part setting step that sets the displayed part to a first part on the basis of the operation information according to a first operation, and sets the displayed part to a second part on the basis of the operation information according to a second operation related to the first operation; and
a display controlling step of displaying the part of the display object set by the displayed part setting step,
wherein the displayed part setting step sets the displayed part at a first interval on the basis of the operation information according to the first operation, and sets the displayed part at a second interval different from the first interval on the basis of the operation information according to the second operation.

16. An information processing method of setting a displayed part in a display object on the basis of a user's operation, comprising:
an operation information acquisition step of acquiring operation information according to the user's operation;
a displayed part setting step that sets the displayed part to a first part on the basis of the operation information according to a first operation, and sets the displayed part to a second part on the basis of the operation information according to a second operation whose type is different from the first operation to an operation target identical to an operation target on which the first operation is performed; and
a display controlling step of displaying the part of the display object set by the displayed part setting step,
wherein the displayed part setting step sets the displayed part at a first interval on the basis of the operation information according to the first operation, and sets the displayed part at a second interval different from the first interval on the basis of the operation information according to the second operation.

17. An information processing system, comprising:
a display section displaying a part of a display object;
an operation input section that detects a user's operation, and outputs operation information according to the detected operation;
an operation information acquisition section that acquires the operation information;
a displayed part setting section that sets the displayed part on the display section to a first part on the basis of the operation information according to a first operation, and sets the displayed part on the display section to a second part on the basis of the operation information according to a second operation related to the first operation; and
a display controller that displays the part of the display object set by the displayed part setting section,
wherein the displayed part setting section sets the displayed part on the display section at a first interval on the basis of the operation information according to the first operation, and sets the displayed part on the display section at a second interval different from the first interval on the basis of the operation information according to the second operation.

18. An information processing system, comprising:
a display section displaying a part of a display object;
an operation input section that detects a user's operation, and outputs operation information according to the detected operation;
an operation information acquisition section that acquires the operation information;
a displayed part setting section that sets the displayed part to a first part on the basis of the operation information according to a first operation, and sets the displayed part on the display section to a second part on the basis of the operation information according to a second operation whose type is different from the first operation to an operation target identical to an operation target on which the first operation is performed; and
a display controller that displays the part of the display object set by the displayed part setting section,
wherein the displayed part setting section sets the displayed part on the display section at a first interval on the basis of the operation information according to the first operation, and sets the displayed part on the display section at a second interval different from the first interval on the basis of the operation information according to the second operation.
